(19) United States
(12) Patent Application Publication
(10) Pub. No.: US 2025/0303520 A1
(43) Pub. Date: Oct. 2, 2025

(54) PRECISION POLISHING GRINDING HEAD WITH PARTITION CONTROLLABLE DEFORMATION

(71) Applicant: Jimei University, Xiamen (CN)

(72) Inventors: Xianling Li, Xiamen (CN); Dalong Zhang, Xiamen (CN); Jingchang Chen, Xiamen (CN); Qingshan Jiang, Xiamen (CN); Bicheng Guo, Xiamen (CN); Zhilong Xu, Xiamen (CN)

(73) Assignee: Jimei University, Xiamen (CN)

(21) Appl. No.: 19/239,882

(22) Filed: Jun. 16, 2025

(30) Foreign Application Priority Data
May 13, 2025 (CN) 202510614532.2

(51) Int. Cl. B24B 47/00; B24B 29/00; F03G 7/06

(52) U.S. Cl. CPC B24B 47/00; B24B 29/00; F03G 7/0614; F03G 7/066; F05B 2280/5006

(57) ABSTRACT

A precision polishing grinding head with partition controllable deformation is disclosed, which belongs to the technical field of precision machining equipment, including a partition base, a positioning block is arranged in a center below the partition base, and a plurality of sets of connecting rod assemblies are arranged above the partition base, a curvature adjusting head is connected at a top end of the connecting rod assembly, a flexible polishing head is arranged above the curvature adjusting head, a protective shell is arranged outside the connecting rod assembly, and the flexible polishing head and the protective shell are connected through a grinding head frame, the device is integrally provided with a driving circuit.

### TECHNICAL FIELD

The present invention relates to the technical field of precision machining equipment, particularly to a precision polishing grinding head with partition controllable deformation.

### BACKGROUND

With the rapid development of modern optical manufacturing technology, optical elements or mechanical parts are widely used in aerospace, national defense, and military industry, astronomical observation, laser systems, and other fields. Strict requirements have been put forward on the machining accuracy and surface quality of optical elements or mechanical parts for major national projects, such as large astronomical telescopes, high-energy laser systems and advanced military optical systems.

As a fundamental process in precision machining of optical elements and mechanical parts, polishing accuracy directly affects the surface shape accuracy, surface roughness and overall performance of elements. In the processing of optical elements, polishing determines the imaging quality and stability of the optical system, whereas in the machining of mechanical parts, polishing affects the wear resistance, corrosion resistance and assembly accuracy of parts. Among many polishing technologies, computer-controlled optical surfacing has become the mainstream method for modern ultra-precision manufacturing due to its high controllability, flexibility and process repeatability. In the polishing process, the curvature radius of the grinding head is one of the key parameters that affects the polishing results, which which in turn directly affect the accuracy of machined surfaces, surface roughness and material removal efficiency. When a grinding head with fixed curvature is machining the edge of a workpiece, it is easy to produce excessive edge removal due to increases in contact line velocity gradient. Additionally, curvature mismatch can reduce contact stiffness, trigger high-frequency chatter, and lead to deterioration of surface curvature. These problems not only affect the imaging quality of optical elements, but also affect the surface quality and service life of mechanical parts. In view of this, the development of a precision polishing grinding head with partition controllable deformation has become an ideal solution to the above challenges.

### SUMMARY

An objective of the present invention is to provide a precision polishing grinding head with partition controllable deformation, through a partition base and an independent shape memory alloy actuator array, which independently controls a curvature radius of a center and an edge of a flexible polishing head, optimizes an edge pressure distribution, brings more stable contact stiffness and more uniform pressure distribution, suppresses or compensates the problem of edge excessive removal or insufficient removal caused by factors such as linear velocity change, improves a surface shape accuracy of a workpiece edge, and achieves finer and more localized surface shape control.

In order to achieve the above objective, the present invention provides a precision polishing grinding head with partition controllable deformation, including a partition base, a positioning block is arranged in a center below the partition base, and a plurality of connecting rod assemblies are arranged above the partition base, the connecting rod assembly includes a shape memory alloy actuator, a curvature adjusting head is connected at a top end of the connecting rod assembly, a flexible polishing head is arranged above the curvature adjusting head, a protective shell is arranged outside the connecting rod assembly, and the flexible polishing head and the protective shell are connected through a grinding head frame, the device is integrally provided with a driving circuit, and the driving circuit controls the shape memory alloy actuator to achieve partition controllable deformation of the flexible polishing head.

Preferably, the partition base is provided with a plurality of partition units, the partition units are uniformly distributed on the surface of the partition base, the number and position of the connecting rod assemblies corresponds to the partition units, and the connecting rod assembly is used for independently controlling the partition of the flexible polishing head.

Preferably, the connecting rod assembly includes a base, the base is connected to the partition base by bolts, a fork rod and an actuator support rod are arranged parallel above the base, a top end of the actuator support rod top is connected to the shape memory alloy actuator, the shape memory alloy actuator and the fork rod are movably connected by a transverse amplification connecting rod, a tail end of the transverse amplification connecting rod is hinged with a first connecting rod, the first connecting rod is hinged with a second connecting rod, the second connecting rod is connected to the curvature adjusting head, and the second connecting rod is used to transmit a displacement of the shape memory alloy actuator to the curvature adjusting head.

Preferably, the shape memory alloy actuator is connected to a head end of the transverse amplification connecting rod, and the fork rod is connected to a middle section of the transverse amplification connecting rod.

Preferably, the outer contour of the curvature adjusting head is hemispherical, \ the curvature adjusting head is provided with a gap, and the gap structure is used to produce controllable deformation when the curvature adjusting head is stressed.

Preferably, the flexible polishing head is directly contact with the curvature adjusting head, and the flexible polishing head adjusts the curvature radius of a working surface through the curvature adjusting head.

Preferably, the drive circuit includes a main control system, the main control system receives an signal input of a processing path storage unit and a workpiece shape measurement module, the main control system inputs a control amount to a shape memory alloy actuator control module, the shape memory alloy actuator control module drives the connecting rod assembly to move and amplify the displacement to act on the curvature adjusting head, the curvature adjusting head controls the flexible polishing head to deform and be used for workpiece machining, and the drive circuit is provided with a power module.

Therefore, the present invention adopts the precision polishing grinding head with partition controllable deformation, which has the following beneficial effects:
1) The “partition controllable” deformation of the curvature of the polishing head is achieved: conventional fixed curvature grinding heads have a curvature mismatch problem when polishing complex curved surfaces, particularly edge areas, leading to uniform contact stress and a tendency to produce defects such as excessive edge removal, medium and high frequency surface errors and scratches. Existing deformable grinding heads can only achieve uniform adjustment of the overall curvature, and cannot be targeted to address the different polishing requirements of the center and edge areas.

Through flexible deformation and curvature adjustment, the present invention can match the local curvature of the workpiece in real time and significantly improve the contact state: through the partition base and independent shape memory alloy actuator array, the curvature radius of the center and edge of the flexible polishing head can be independently controlled, the edge pressure distribution can be optimized, more stable contact stiffness and more uniform pressure distribution can be effectuated, and the problem of excessive or insufficient edge removal caused by factors such as linear velocity changes can be suppressed or compensated. Thus, the surface accuracy of the workpiece edge can be improved, and finer and more localized surface shape control can be achieved.
2) Solid-state drive allows for a relatively compact structure: the shape memory alloy actuator is a solid-state drive element, which can achieve the required driving force and displacement in a relatively compact space with the transverse amplification connecting rod, and is easy to integrate into existing polishing equipment or robotic systems.
3) The present invention can be applied to precise polishing of various complex curved surfaces, being particularly suitable for the processing of high-precision optical elements, aerospace parts, precision medical devices and the like, and can significantly improve surface quality and surface shape accuracy.

Further detailed descriptions of the technical scheme of the present invention can be found in the accompanying drawings and embodiments.

### BRIEF DESCRIPTION OF THE DRAWINGS

FIG. 1 is a schematic diagram of an internal structure of an embodiment of a precision polishing grinding head with partition controllable deformation according to the present invention.

FIG. 2 is an external view of an embodiment of a precision polishing grinding head with partition controllable deformation according to the present invention.

FIG. 3 is a structural diagram of a connecting rod assembly of an embodiment of a precision polishing grinding head with partition controllable deformation according to the present invention.

FIG. 4 is a structural diagram of a curvature adjusting head of an embodiment of a precision polishing grinding head with partition controllable deformation according to the present invention.

FIG. 5 is a principal diagram of curvature radius adjustment in a central area of a precision polishing grinding head with partition controllable deformation according to the present invention.

FIG. 6 is a principal diagram of curvature radius adjustment of an edge area of an embodiment of a precision polishing grinding head with partition controllable deformation according to the present invention.

FIG. 7 is a principal diagram of a drive circuit control of an embodiment of a precision polishing grinding head with partition controllable deformation according to the present invention.

Reference numerals in figures:

1, a partition base; 2, a positioning block; 3, a connecting rod assembly; 31, a base; 32, a bolt; 33, a fork rod; 34, an actuator support rod; 35, a shape memory alloy actuator; 36, a transverse amplification connecting rod; 37, a first connecting rod; 38, a second connecting rod; 4, a curvature adjusting head; 5, a grinding head frame; 6, a flexible polishing head; 7, a protective shell.

### DETAILED DESCRIPTION OF THE EMBODIMENTS

The technical scheme of the present invention is further explained below by drawings and embodiments.

Unless otherwise defined, the technical or scientific terms used in the present invention shall be those to which the present invention belongs. As used herein, the terms “first”, “second”, and the like do not denote any order, quantity, or importance, but rather are used to distinguish one element from another. Similar words, such a “comprise” or “include” means that the elements or items preceding the word encompass the elements or items listed after the word and equivalents thereof, but do not exclude other elements or items. Terms such as “connected” or “connecting” are not limited to physical or mechanical connections, but may include electrical connections, whether direct or indirect. “Up”, “down”, “left”, “right”, etc., are only used to indicate a relative positional relationship, which may change accordingly when the absolute position of the object being described changes.

### Embodiment 1

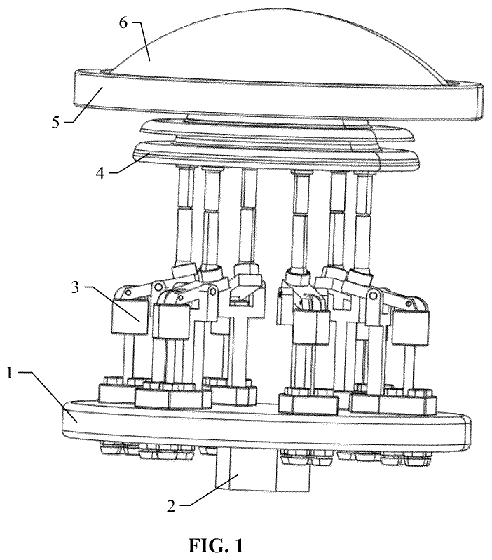

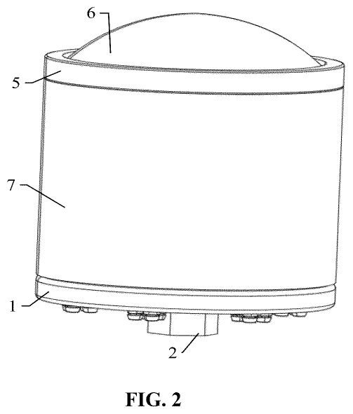

The present invention provides a precision polishing grinding head with partition controllable deformation, as shown in FIG. 1 and FIG. 2, including the partition base 1, the positioning block 2 is arranged in the center below the partition base 1, and a plurality of sets of connecting rod assemblies 3 are arranged above the partition base 1, the partition base 1 is provided with a plurality of partition units, the partition unit is uniformly distributed on the surface of the partition base 1, the number and position of the connecting rod assemblies 3 correspond to the partition units. The partition base 1 can achieve the partition control of the curvature radius of the polishing grinding head working surface, the partition base 1 includes a plurality of independent partition units, each partition unit can independently adjust its corresponding curvature radius to adapt to the optical elements with complex surfaces. The number of connecting rod assemblies 3 and partition units of the polishing grinding head of the embodiment is 6, and are uniformly distributed on the upper surface of the partition base 1.

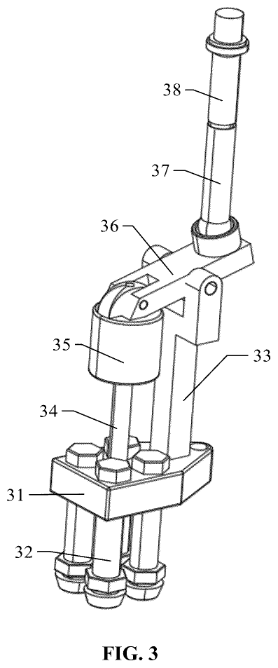

The connecting rod assembly 3 is shown in FIG. 3, including the base 31, the base 31 is connected to the partition base 1 by bolts 32, the fork rod 33 and the actuator support rod 34 are arranged parallel above the base 31, the top end of the actuator support rod top 34 is connected to the shape memory alloy actuator 35, the shape memory alloy actuator 35 and the fork rod 33 are movably connected by the transverse amplification connecting rod 36, the tail end of the transverse amplification connecting rod 36 is hinged with the first connecting rod 37, the first connecting rod 37 is hinged with the second connecting rod 38. The shape memory alloy actuator 35 is connected to the head end of the transverse amplification connecting rod 36, and the fork rod 33 is connected to the middle section of the transverse amplification connecting rod 36. The shape memory alloy actuator 35 deforms through current excitation to achieve the precise control of the curvature radius of the 6 working surface of the flexible polishing head. The core function of the connecting rod assembly 3 is to accurately amplify the force and displacement and transmit it to the curvature adjustment head 4 by adjusting a proportional relationship between the fulcrum position and the lever arm length. In this embodiment, the material of the shape memory alloy actuator 35 is nickel-titanium alloy with a good shape memory effect and fatigue resistance.

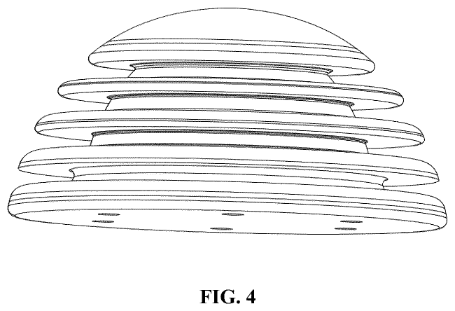

The curvature adjusting head 4 is connected at the top end of the connecting rod assembly 3, the curvature adjusting head 4 is shown in FIG. 4, the outer contour is hemispherical, and the curvature adjusting head 4 is provided with multiple layers of gaps. The flexible polishing head 6 is arranged above the curvature adjusting head 4, the flexible polishing head 6 is directly contact with the curvature adjusting head 4, and the flexible polishing head 6 adjusts the curvature radius of the working surface through the curvature adjusting head 4. The flexible polishing head 6 directly contacts the surface of the optical element, and the optical element is precisely polished, the flexible polishing head 6 is required to be a flexible material with high elastic modulus and wear resistance to ensure that it can adapt to the surface of the optical element with different curvatures during the polishing process.

The curvature adjusting head 4 adopts a multi-layer superimposed structure design, wherein there is an accurately calculated gap between each layer, so that it can produce controllable deformation when it is subjected to the force of the connecting rod assembly 3. The design of the multi-layer gap structure not only improves the flexibility of the curvature adjusting head 4, but also makes the curvature adjustment smoother and more continuous, avoiding the discontinuous deformation that possibly occurs during the adjustment process of a conventional single-layer structure. In the embodiment, the material of the curvature adjusting head 4 is titanium alloy with an elastic modulus of 80-120 GPa, which has excellent elastic recovery ability and long-term stability.

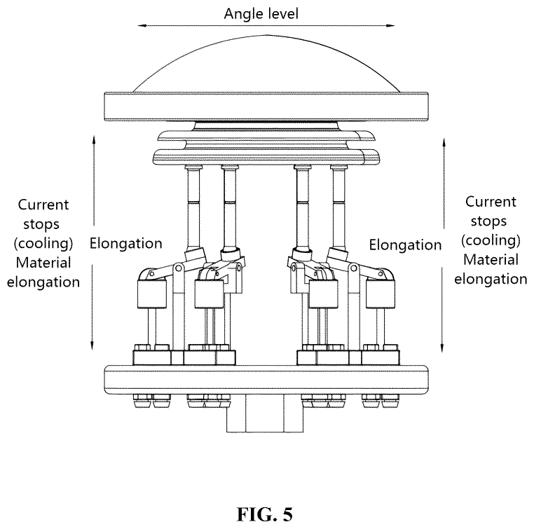

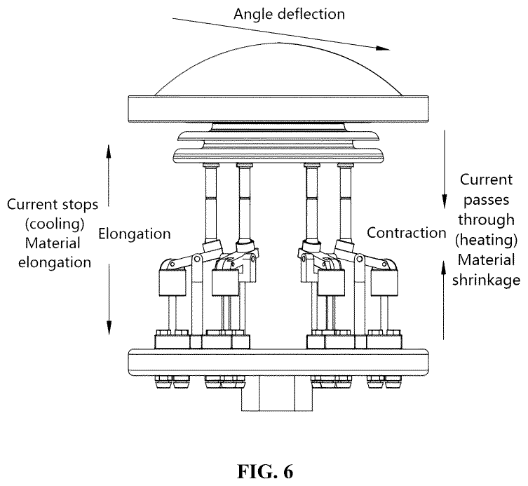

The adjustment of the curvature radius of the working surface of the flexible polishing head 6 is as follows: when the flexible polishing head 6 is pushed or pulled by the curvature adjusting head 4, accurate and controllable shape changes are effectuated, and the curvature adjusting head 4 is adjusted by the force of the connecting rod assembly 3. In this way, the flexible polishing head 6 can adjust the curvature radius of its working surface in real time and accurately to adapt to workpiece surfaces with different curvatures when polishing different positions of the workpiece. By controlling the axial (up and down) movement of the curvature adjusting head 4, the curvature radius of the central area of the flexible polishing head 6 can be changed, as shown in FIG. 5; by controlling the angle swing (tilt) of the curvature adjusting head 4, the curvature radius of the edge area of the flexible polishing head 6 can be adjusted, as shown in FIG. 6. Accordingly, the accuracy and adaptability of the polishing process are improved by this design.

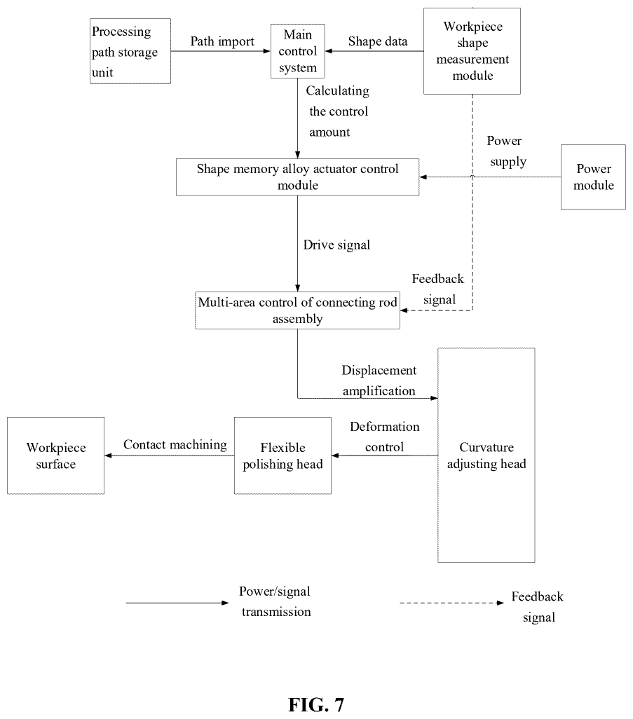

The protective shell 7 is arranged outside the connecting rod assembly 3, and the flexible polishing head 6 and the protective shell 7 are connected through the grinding head frame 5. The device is further integrally provided with a driving circuit. The driving circuit is used to output the excitation current to the shape memory alloy actuator 35, and the austenite phase transformation of the memory alloy is triggered by the Joule heat effect to produce deformation, the control principle is shown in FIG. 7. The driving circuit includes the main control system, wherein the main control system receives the signal input of the processing path storage unit and the workpiece shape measurement module, the main control system inputs the control amount to the shape memory alloy actuator control module, the shape memory alloy actuator control module drives the connecting rod assembly to move and amplify the displacement to act on the curvature adjusting head, the curvature adjusting head controls the flexible polishing head to deform and be used for workpiece machining, and the drive circuit is provided with the power module to provide power supply for the whole system. Specifically, the drive circuit applies a specific control current to each shape memory alloy actuator 35, wherein the heat generated by the current will trigger the phase transition of the shape memory alloy material, elongate or shorten it, and produce accurate and controllable small displacements. This displacement is then magnified by the transverse amplification connecting rod 36, and the amplified force or displacement directly drives the curvature adjusting head 4 to produce the corresponding axial displacement or angle swing. Each partition of the partition base 1 is provided with an independent shape memory alloy actuator 35. The whole device is controlled by the drive circuit, and the expansion amount of the shape memory alloy actuator 35 in different partitions can be coordinated to accurately control the tilt angle and attitude of the curvature adjusting head 4. Finally, the independent and fine control of the curvature radius of different areas of the flexible polishing head 6 is achieved.

When applying the polishing grinding head of the embodiment, the specific working process is as follows:

S1, the workpiece to be processed is mounted in a special fixture to ensure that the surface of the workpiece is completely immersed in the polishing liquid medium. For optical elements, they are generally fixed by a vacuum adsorption system; for mechanical parts, mechanical fixtures or electromagnetic adsorption systems can be selected for fixing according to the material characteristics and shape of the workpiece.

S2, the polishing grinding head of the embodiment is mounted on the polishing equipment through the positioning block 2, the polishing grinding head is controlled to approach the workpiece surface, wherein the polishing grinding head gently contacts the surface of the workpiece to complete tool setting, and the system automatically records the current position as a processing reference surface.

S3, a rotating mechanism is started to make the polished workpiece rotate at high speed, and the polishing grinding head polishes the workpiece based on the shape and processing requirements of the workpiece and according to the preset polishing path; during the polishing process, the polishing head can self-adjust the curvature radius of the working surface according to the curvature of the polishing area to adapt the processing requirements of complex surfaces.

S4, the driving circuit outputs a programmable excitation current to the shape memory alloy actuator 35, which triggers the austenite transformation of the memory alloy through the Joule thermal effect to generate controllable deformation. The deformation is transmitted to the flexible polishing head 6 through the connecting rod assembly 3, so as to achieve the dynamic adjustment of the curvature radius of the working surface. The partition base 1 adopts the independent control unit array, and each partition can apply excitation separately to achieve local correction of the curvature of the working surface; for optical elements, this adjustment can significantly improve surface roughness and surface shape accuracy; for mechanical parts, this adjustment can optimize the surface quality and material removal efficiency.

S5, in the polishing process, the workpiece shape measurement module monitors the surface shape of the workpiece in real time, and feeds the measurement data back to the main control system, wherein, according to the preset surface shape accuracy requirements, the main control system calculates the amount of the curvature adjustment required for each partition and adjusts the excitation current of each shape memory alloy actuator control module accordingly to form a closed-loop control system to ensure the accuracy stability in the polishing process.

Therefore, the present invention adopts the above-mentioned precision polishing grinding head with partition controllable deformation wherein, through the partition base and independent shape memory alloy actuator array, the curvature radius of the center and edge of the flexible polishing head can be independently controlled, the edge pressure distribution can be optimized, more stable contact stiffness and more uniform pressure distribution can be brought, and the problem of excessive or insufficient edge removal caused by factors such as linear velocity changes can be suppressed or compensated. Thus, the surface accuracy of the workpiece edge can be improved, and finer and more localized surface shape control can be achieved. Additionally, the shape memory alloy actuator is a solid-state drive element, which can achieve the required driving force and displacement in a relatively compact space with the transverse amplification connecting rod, and can be easily integrated into existing polishing equipment or robot systems.

Finally, it should be noted that the above examples are merely used for describing the technical solutions of the present invention, rather than limiting the same. Although the present invention has been described in detail with reference to the preferred examples, those of ordinary skill in the art should understand that the technical solutions of the present invention may still be modified or equivalently replaced. However, these modifications or substitutions should not make the modified technical solutions deviate from the spirit and scope of the technical solutions of the present invention.

What is claimed is:

1. A precision polishing grinding head with partition controllable deformation, comprising:
a partition base, wherein a positioning block is arranged in a center below the partition base, and a plurality of connecting rod assemblies are arranged above the partition base;
wherein the connecting rod assembly comprises a shape memory alloy actuator, a curvature adjusting head is connected at a top end of the connecting rod assembly, a flexible polishing head is arranged above the curvature adjusting head, a protective shell is arranged outside the connecting rod assembly, and, the flexible polishing head and the protective shell are connected through a grinding head frame;
wherein the device is integrally provided with a driving circuit, and the driving circuit controls the shape memory alloy actuator to achieve partition controllable deformation of the flexible polishing head.

2. The precision polishing grinding head with partition controllable deformation according to claim 1, wherein the partition base is provided with a plurality of partition units, the plurality of partition units are uniformly distributed on the surface of the partition base, the number and position of the connecting rod assemblies correspond to the partition units, and the connecting rod assembly is used for independently controlling the partition of the flexible polishing head.

3. The precision polishing grinding head with partition controllable deformation according to claim 1, wherein,
the connecting rod assembly comprises a base and the base is connected to the partition base by bolts;
wherein a fork rod and an actuator support rod are arranged parallel above the base and a top end of the actuator support rod top is connected to the shape memory alloy actuator;
wherein the shape memory alloy actuator and the fork rod are movably connected by a transverse amplification connecting rod, a tail end of the transverse amplification connecting rod is hinged with a first connecting rod, the first connecting rod is hinged with a second connecting rod, the second connecting rod is connected to the curvature adjusting head, and wherein the second connecting rod is used to transmit a displacement of the shape memory alloy actuator to the curvature adjusting head.

4. The precision polishing grinding head with partition controllable deformation according to claim 3, wherein,
the shape memory alloy actuator is connected to a head end of the transverse amplification connecting rod, and the fork rod is connected to a middle section of the transverse amplification connecting rod.

5. The precision polishing grinding head with partition controllable deformation according to claim 1, wherein,
the outer contour of the curvature adjusting head is hemispherical, and the curvature adjusting head is provided with a gap, wherein the gap structure is used to produce controllable deformation when the curvature adjusting head is stressed.

6. The precision polishing grinding head with partition controllable deformation according to claim 1, wherein,
the flexible polishing head is in direct contact with the curvature adjusting head, and the flexible polishing head is capable of adjusting the curvature radius of a working surface through the curvature adjusting head.

7. The precision polishing grinding head with partition controllable deformation according to claim 3, wherein,
the drive circuit comprises a main control system and the main control system receives an signal input of a processing path storage unit and a workpiece shape measurement module,
wherein the main control system inputs a control value to a shape memory alloy actuator control module,
wherein the shape memory alloy actuator control module drives the connecting rod assembly to move and amplify the displacement of the shape memory actuator to the curvature adjusting head,
wherein the curvature adjusting head controls the flexible polishing head to deform and be used for workpiece machining,
and wherein the drive circuit is provided with a power module.
